(19) United States
(12) Patent Application Publication
(10) Pub. No.: US 2025/0279228 A1
(43) Pub. Date: Sep. 4, 2025

(54) GUIDE SLEEVE

(71) Applicant: AISIN (SUZHOU) TECHNICAL CENTER CO., LTD., Suzhou (CN)

(72) Inventors: Guodong GAO, Suzhou (CN); Yangyang ZHU, Suzhou (CN)

(73) Assignee: AISIN (SUZHOU) TECHNICAL CENTER CO., LTD., Suzhou (CN)

(21) Appl. No.: 18/969,534

(22) Filed: Dec. 5, 2024

(30) Foreign Application Priority Data
Feb. 29, 2024 (CN) 202420389409.6

(51) Int. Cl. H01B 17/26; H01B 17/30

(52) U.S. Cl. CPC H01B 17/265; H01B 17/303

(57) ABSTRACT

A guide sleeve with good waterproof performance. A plurality of cables passing through a mounted portion are fixed and guided by a plurality of through holes penetrating the guide sleeve. The guide sleeve includes: a mounting portion, where the mounting portion is mounted on the mounted portion, and one end of each through hole is opened in the mounting portion; a main body portion, where the main body portion is connected to the mounting portion; and a plurality of guide portions, where the plurality of guide portions branch from the side of the main body portion opposite to the mounting portion, each through hole penetrates the corresponding guide portion, and the other end of each through hole is opened at an end of the corresponding guide portion away from the main body portion.

### TECHNICAL FIELD

The invention relates to a waterproof guide sleeve for fixing a cable.

### BACKGROUND ART

Cables (electrical cables, wires, etc.) sometimes need to pass from one side of an installed component, such as a vehicle panel, to the other side. In order to fix and guide the cables, a guide sleeve for the cables to pass through is installed on the installed component.

In the prior art, a guide sleeve installed on a vehicle panel is known, which has a main body and a mounting portion. The mounting portion is arranged at one end of the main body and installed on the vehicle panel. Two through holes penetrate the guide sleeve and are opened at the end face of the integrally formed main body.

However, because the positions of the two through holes on the end face of the main body are fixed to each other, when the cables passing through the two through holes are operated and moved in a direction away from each other, a force is applied on the two through holes in a direction away from each other. This can easily lead to a gap between the through hole and the cable and thus external rainwater and the like easily enter the interior of the vehicle through the gap via the guide sleeve, and consequently a problem of water leakage is caused.

### SUMMARY OF THE INVENTION

### Problem to be Solved by the Invention

The invention is made in view of the above problem, and an objective of the invention is to provide a guide sleeve with good waterproof performance.

### Means for Solving the Problem

In order to achieve the above objective, in the guide sleeve of the invention, a plurality of cables passing through a mounted portion are fixed and guided by means of a plurality of through holes penetrating the guide sleeve, and the guide sleeve includes: a mounting portion, where the mounting portion is mounted on the mounted portion, and one end of each through hole is opened in the mounting portion; a main body portion, where the main body portion is connected to the mounting portion; and a plurality of guide portions, where the plurality of guide portions branch from the side of the main body portion opposite to the mounting portion, each through hole penetrating the corresponding guide portion, and the other end of each through hole is opened at an end of the corresponding guide portion away from the main body portion.

According to this structure, the guide portion branches from the side of the main body portion opposite to the mounting portion, so that the plurality of wire portions are separated from each other. Therefore, when the plurality of cables move in different directions, each guide portion moves with the movement of the cables, and each guide portion is not pulled due to the movement of the adjacent guide portions in different directions. Therefore, in the through hole through which the cable passes, it is difficult to generate a gap between the cable and the inner wall of the through hole, and the waterproof performance is good.

In addition, preferably, in the guide sleeve, a scaling portion is provided at an end of the guide portion away from the main body portion to seal a gap between the cable and the through hole, and in an extension direction of the through hole, a portion of the guide portion where the guide portion branches from the main body portion is located closer to the mounting portion relative to the scaling portion.

According to the above structure, because the portion of the guide portion where the guide portion branches from the main body portion is located closer to the mounting portion relative to the sealing portion in the extension direction of the through hole, the influence of the pulling of the cable on the guide portion at the sealing portion can be reduced, thereby fully ensuring waterproof performance.

In addition, preferably, in the guide sleeve, in the extension direction of the through hole, a length of the guide portion is less than or equal to a length of the main body portion.

According to the above structure, the guide sleeve can provide good waterproof performance and ensure the effect of fixing and guiding the cable.

In addition, preferably, in the guide sleeve, in a direction orthogonal to the extension direction of the through hole, a distance between the guide portions is ⅕ to ¼ of the length of the main body portion.

According to the above structure, the guide sleeve can provide good waterproof performance and ensure the effect of fixing and guiding the cable.

In addition, preferably, in the guide sleeve, the distance between the plurality of guide portions gradually increases in a direction in which the plurality of guide portions branch from the main body portion.

According to the above structure, the guide sleeve can provide good waterproof performance and ensure the effect of fixing and guiding the cable.

In addition, preferably, in the guide sleeve, two guide portions are provided.

In addition, preferably, in the guide sleeve, the guide portions, the main body portion, and the mounting portion are an integrally formed rubber part.

According to the above structure, because the guide portions, the main body portion, and the mounting portion are an integrally formed rubber part, the guide portions separated from each other are more likely to move following the movement of the cable, thereby better ensuring waterproof performance.

In addition, preferably, in the above guide sleeve, the sealing portion is formed by making an inner surface of the through hole protrude radially inward of the through hole.

According to the above structure, the sealing portion can be formed by a simple structure.

### BRIEF DESCRIPTION OF THE DRAWINGS

FIG. 1 is a perspective view of a guide sleeve according to a preferred embodiment of the invention.

FIG. 2 is a schematic cross-sectional view of the guide sleeve cut along a plane passing through the axes of the two through holes.

FIG. 3 is a schematic side view for illustrating a groove structure of the guide sleeve according to a preferred embodiment, (a) is corresponding to a groove structure of one size, and (b) is corresponding to a groove structure of another size.

FIG. 4 is a top view of a guide sleeve of a modified example.

FIG. 5 is a top view of a guide sleeve of another modified example.

### EMBODIMENTS OF THE INVENTION

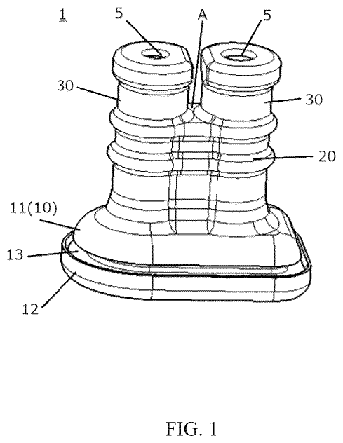

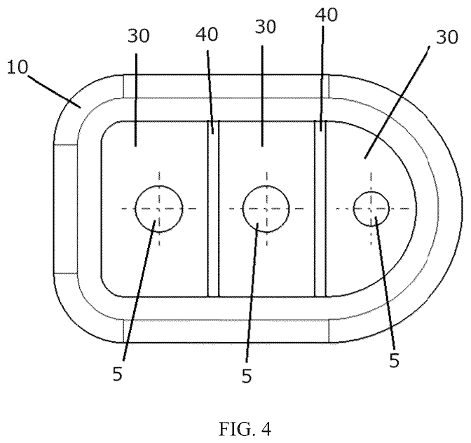

Hereinafter, a guide sleeve 1 of the preferred embodiment of the invention is described with reference to FIGS. 1 to 5. In addition, the description of the directions of “up”, “down”, “left”, and “right” in the following description and the drawings is for the convenience of description and does not limit the direction of the guide sleeve in actual use.

In the guide sleeve 1 of the invention, a plurality of cables 7 passing through the mounted portion are fixed and guided by means of a plurality of through holes 5 penetrating the guide sleeve 1. The mounted portion is, for example, a bracket, a sheet metal, or a panel and the like. More specifically, in this embodiment, the mounted portion is a panel provided on the vehicle door.

As shown in FIGS. 1 to 3, the guide sleeve 1 has a mounting portion 10, a main body portion 20, and two guide portions 30 from bottom to top. The two guide portions 30, the main body portion 20, and the mounting portion 10 are an integrally formed rubber part.

The mounting portion 10 is mounted on the mounted portion, and one end of each through hole 5 is opened in the mounting portion 10. The mounting portion 10 includes a first skirt portion 11, a second skirt portion 12, and a locking part 13. The first skirt portion 11 is continuously provided at the lower end of the main body portion 20. The second skirt portion 12 is continuously provided from the lower side of the first skirt portion 11. A groove-shaped locking portion 13 is formed at the connection between the first skirt portion 11 and the second skirt portion 12. The contours of the first skirt portion 11, the second skirt portion 12, and the locking portion 13 are formed into a shape corresponding to the mounting portion 10. When the guide sleeve 1 is mounted on the mounted portion, the first skirt portion 11 and the second skirt portion 12 clamp the mounted portion from both sides, so that the mounted portion is locked in the locking part 13.

The main body portion 20 is connected to the mounting portion 10. Specifically, the mounting portion 10 is provided at one end of the main body portion 20 and is integrally formed with the main body portion 20. The main body portion 20 is formed in a columnar shape and is perpendicular to the bottom surface of the mounting portion 10, that is, the main body portion 20 is perpendicular to the mounting surface of the mounting portion 10. The operator can mount the mounting portion 10 of the guide sleeve 1 on the mounted portion by holding the main body portion 20 and applying force to the guide sleeve 1.

In this embodiment, two guide portions 30 are provided, but the number of guide portions 30 can be arbitrarily set to at least two as needed. The two guide portions 30 branch from a side of the main body portion 20 opposite to the mounting portion 10, and each through hole 5 penetrates a corresponding guide portion 30, and the other end of each through hole 5 is opened at the end of the corresponding guide portion 30 away from the main body portion 20. That is, the through hole 5 penetrates from the main body portion 20 to the mounting portion 10 from bottom to top, and then penetrates the guide portion 30 and is opened at both ends of the mounting portion 10 and the guide portion 30, and the cables 7 pass through the mounting portion 10, the main body portion 20, and the guide portion 30, and are fixed and guided by the guide sleeve 1. In addition, the two guide portions 30 are separated and form a groove 40 between each other, the bottom of the groove 40 is the portion A where the guide portion 30 branches from the main body portion 20.

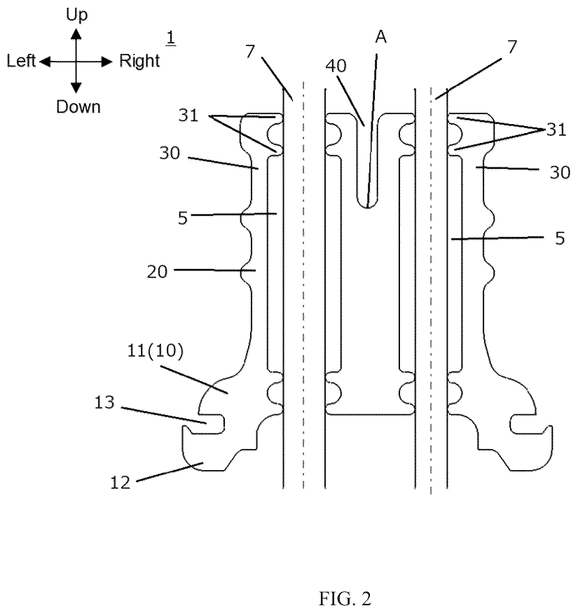

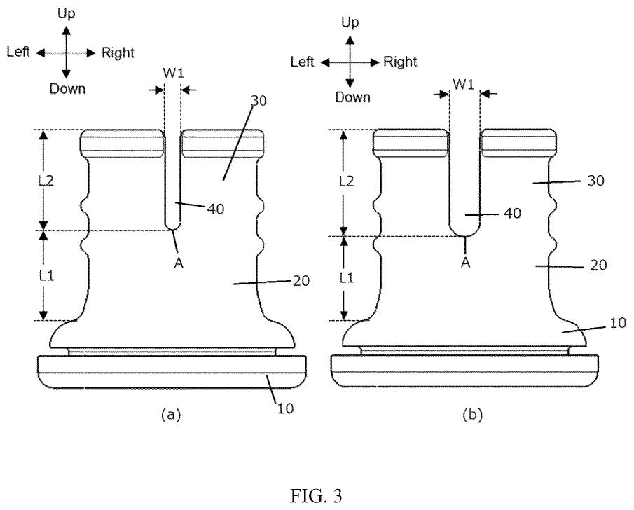

A scaling portion 31 is provided at an end of the guide portion 30 away from the main body portion 20 (the upper end in FIGS. 2 and 3) to seal the gap between the cable 7 and the through hole 5, and the sealing portion 31 is formed by making the inner surface of the through hole 5 protrude radially inward of the through hole 5. In the extension direction of the through hole 5, the portion A of the guide portion 30 where the guide portion 30 branches from the main body portion 20 is located closer to the mounting portion 10 relative to the scaling portion 31. That is, referring to FIG. 2, the portion A where the guide portion 30 branches from the main body portion 20 is located below the sealing portion 31. When the cable 7 passes through the through hole 5, the sealing portion 31 is in close contact with the outer surface of the cable 7, the gap between the cable 7 and the through hole 5 is sealed and prevent foreign matter such as water droplets and dust from entering the gap between the cable 7 and the through hole 5.

Referring to FIG. 3, the dimension structure of the guide sleeve 1 of the preferred embodiment is described.

In the extension direction of the through hole 5 (that is, an up-down direction), a length L2 of the guide portion 30 is less than or equal to a length L1 of the main body portion 20.

Moreover, in a direction orthogonal to the extension direction of the through hole 5, a distance W1 between the guide portions 30 is ⅕ to ¼ of the length L1 of the main body portion 20. Referring to FIG. 3, in this embodiment, the two guide portions 30 branch from the portion A in a manner that the distance between the two guide portions 30 is substantially constant, and the two through holes 5 are also configured to extend in parallel, and the extension direction of the through hole 5 is the up-down direction, and the direction orthogonal to the extension direction of the through hole 5 is a left-right direction. The distance W1 between the guide portions 30, that is, the width of the groove 40 in the left-right direction, is ⅕ to ¼ of the length L1 of the main body portion 20.

In FIG. 3, the distance W1 in (a) is smaller than the distance W1 in (b). In practice, the size of the distance W1 and the length L2 can be set accordingly according to the specifications of the cable 7.

According to the guide sleeve 1 of this embodiment, when the two cables 7 corresponding to the two guide portions 30 are operated in a direction in which the distance between the two cables 7 increases as the two cables 7 move away from the portion A, that is, when the two cables 7 are pulled apart in a V shape, the guide portions 30 separated from each other by branching can prevent the problem of generating a gap in the part where the cable 7 contacts the guide portion 30 in the guide portion 30, thereby fully ensuring the waterproof performance, and by setting the above dimensions, the fixing and guiding effect of the main body portion 20 on the cable 7 can also be fully ensured.

Above, the preferred embodiment of the invention is described, but the invention is not limited to the above embodiment, and appropriate changes can be made within the scope of the main purpose of the invention.

For example, in the above embodiment, the guide portion, the main body portion, and the mounting portion are defined as an integrally formed rubber part. However, the invention is not limited to this. The guide portion, the main body portion, and the mounting portion can also be separate structures from each other.

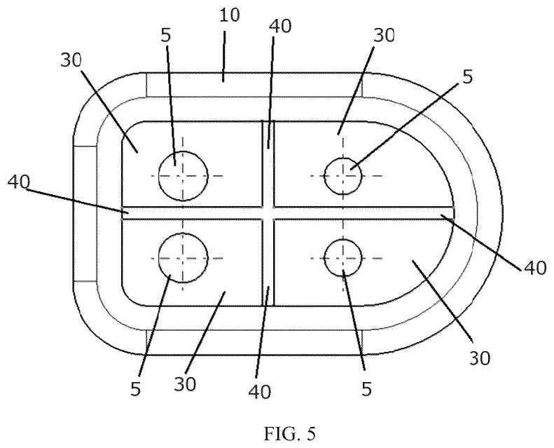

For example, in the above embodiment, two guide portions are provided, but the invention is not limited to this. More than three guide portions can also be provided, and correspondingly more than three through holes and more than three cables can also be provided. For example, as shown in FIG. 5, three through holes are arranged in one direction and separated from each other by grooves. For example, as shown in FIG. 6, four through holes are arranged in two rows and separated from each other by grooves. However, these are only examples, and the number and arrangement of through holes can be changed according to the actual situation of the cable.

For example, in the above embodiment, the distance W1 between the two guide portions is constant in the up-down direction, but the invention is not limited to this. The distance W1 between the plurality of guide portions can also gradually increase in the direction in which the plurality of guide portions branch from the main body portion. In this case, the distance W1, for example, can be represented by the average value of the distances in the branching direction.

In addition, in the above embodiment, the sealing portion is formed by making the inner surface of the through hole protrude radially inward of the through hole. However, the scaling portion is not limited to being provided integrally with the main body portion of the guide sleeve, and can also be provided separately from the guide sleeve, such as a scaling ring or a dust cover.

The invention has been described above with reference to specific examples. However, the present invention is not limited to the above embodiments. Designs obtained by the person skilled in the art by making appropriate design changes to the above embodiments are also included in the scope of the present invention as long as the designs have the features of the present invention.

### REFERENCE SIGNS LIST

1 Guide sleeve
5 Through hole
7 Cable
10 Mounting portion
11 First skirt portion
12 Second skirt portion
13 Locking part
20 Main body portion
30 Guide portion
31 Scaling portion
40 Groove
A Bifurcation part

1. A guide sleeve, wherein a plurality of cables passing through a mounted portion are fixed and guided by means of a plurality of through holes penetrating the guide sleeve, comprising:
a mounting portion, wherein the mounting portion is mounted on the mounted portion, and one end of each through hole is opened in the mounting portion;
a main body portion, wherein the main body portion is connected to the mounting portion; and
a plurality of guide portions, wherein the plurality of guide portions branch from the side of the main body portion opposite to the mounting portion, each through hole penetrates the corresponding guide portion, and the other end of each through hole is opened at an end of the corresponding guide portion away from the main body portion.

2. The guide sleeve according to claim 1, wherein
a sealing portion is provided at an end of the guide portion away from the main body portion to seal a gap between the cable and the through hole, and in an extension direction of the through hole, a portion of the guide portion where the guide portion branches from the main body portion is located closer to the mounting portion relative to the sealing portion.

3. The guide sleeve according to claim 2, wherein
in the extension direction of the through hole, a length of the guide portion is less than or equal to a length of the main body portion.

4. The guide sleeve according to claim 3, wherein
in a direction orthogonal to the extension direction of the through hole, a distance between the guide portions is ⅕ to ¼ of the length of the main body portion.

5. The guide sleeve according to claim 1, wherein
the distance between the plurality of guide portions gradually increases in a direction in which the plurality of guide portions branch from the main body portion.

6. The guide sleeve according to claim 1, wherein
two guide portions are provided.

7. The guide sleeve according to claim 1, wherein
the guide portions, the main body portion, and the mounting portion are an integrally formed rubber part.

8. The guide sleeve according to claim 2, wherein
the sealing portion is formed by making an inner surface of the through hole protrude radially inward of the through hole.
